(19) United States
(12) Patent Application Publication
(10) Pub. No.: US 2009/0056534 A1
(43) Pub. Date: Mar. 5, 2009

(54) Piston for an Internal Combustion Engine

(76) Inventor: Rainer Scharp, Vaihingen (DE)

Correspondence Address: COLLARD & ROE, P.C., 1077 NORTHERN BOULEVARD, ROSLYN, NY, 11576, US

(21) Appl. No.: 12/225,569

(22) PCT Filed: Mar. 23, 2007
(86) PCT No.: PCT/DE2007/000530

§ 371 Date: Sep. 24, 2008

(30) Foreign Application Priority Data
Mar. 25, 2006 (DE) 10 2006 013 905.4

(51) Int. Cl. F02F 3/00

(52) U.S. Cl. 92/239; 123/193.6

(57) ABSTRACT

The invention relates to a piston (10, 110, 210, 310) for an internal combustion engine, comprising a piston head (11, 111, 211, 311) and a piston shaft (16, 116, 216, 316). The invention is characterized in that on the internal wall (22, 122, 222, 322) of the piston shaft (16, 116, 216, 316) at least one reinforcing rib (25, 125, 225, 325) is provided that extends in parallel to the piston center axis (A).

The present invention relates to a piston for an internal combustion engine, having a piston head and a piston skirt.

Pistons for internal combustion engines are exposed to significant stresses during operation. This holds true, in particular, if the piston is provided with a long piston skirt, relative to the piston diameter. Such a piston has relatively large piston skirt regions that are particularly exposed to lateral force stresses.

The European patent EP 0 188 108 B1 and the Japanese patent application 2000-320 397 A describe pistons for internal combustion engines, whose piston skirt provided with a radially circumferential thickened part along the inside wall. Such a thickened part is non-effective in the case of lateral force stresses.

The task of the present invention consists in making available a piston for an internal combustion engine, having a piston head and a piston skirt, which withstands lateral force stresses in particularly reliable manner.

The solution consists in a piston having the characteristics of claim 1. According to the invention, it is provided that at least one reinforcement rib that runs parallel to the center piston axis is provided on the inside wall of the piston skirt.

The measure according to the invention, of providing the inside wall of the piston skirt with at least one reinforcement rib oriented longitudinally, i.e. parallel to the center piston axis, brings about the result that the piston skirt is stabilized in the axial direction, so that it withstands lateral force stresses that occur during operation, in particularly reliable manner. In this connection, the number and arrangement of the reinforcement rib(s) is completely variable, and is dependent only on the overall design and/or the field of use of the piston. The measure according to the invention is suitable for any desired piston design, for example one-part pistons or multi-part pistons, composite pistons, etc.

Advantageous further developments are evident from the dependent claims.

In a preferred embodiment, the at least one reinforcement rib extends from the region of the piston head or from the upper region of the piston skirt all the way into the region of the free end of the piston skirt. As a result, the piston skirt is reinforced over its entire axial length, and this results in particularly reliable stabilization.

The at least one reinforcement rib preferably makes a constant transition into the region of the piston head or the upper region of the piston skirt, so that the forces that act on the piston skirt are absorbed and passed away in unhindered manner.

In advantageous manner, two or more reinforcement ribs are provided, depending on the type and the intensity of the stresses that occur. In particular, it has proven to be particularly effective to provide two reinforcement ribs that lie diametrically opposite one another, without increasing the weight of the piston too much. It is recommended, in this connection, to dispose the two reinforcement ribs crosswise to the center longitudinal axis of a pin bore provided in the piston.

The at least one reinforcement rib can have any desired cross-section, whereby an essentially trapezoid, arc-shaped, semicircular, or rectangular cross-section has proven to be practical.

The at least one reinforcement rib can form a connection crosspiece between the piston head and the piston skirt, particularly if a cooling channel having a cover on the open underside is provided in the piston head.

Exemplary embodiments of the invention will be described in greater detail in the following, using the attached drawings. These show, in a schematic representation, not to scale:

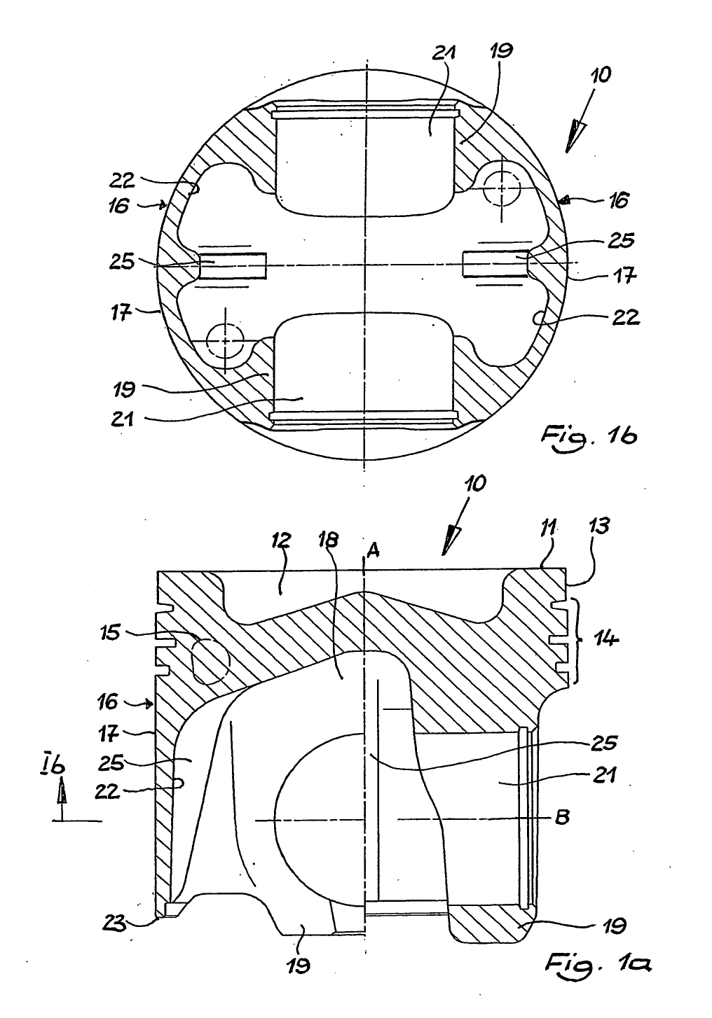

FIG. 1a a first exemplary embodiment of a piston according to the invention, in a two-part, sectional representation, whereby the right part is rotated by 90° relative to the left part;

FIG. 1b a section along the line Ib in FIG. 1a;

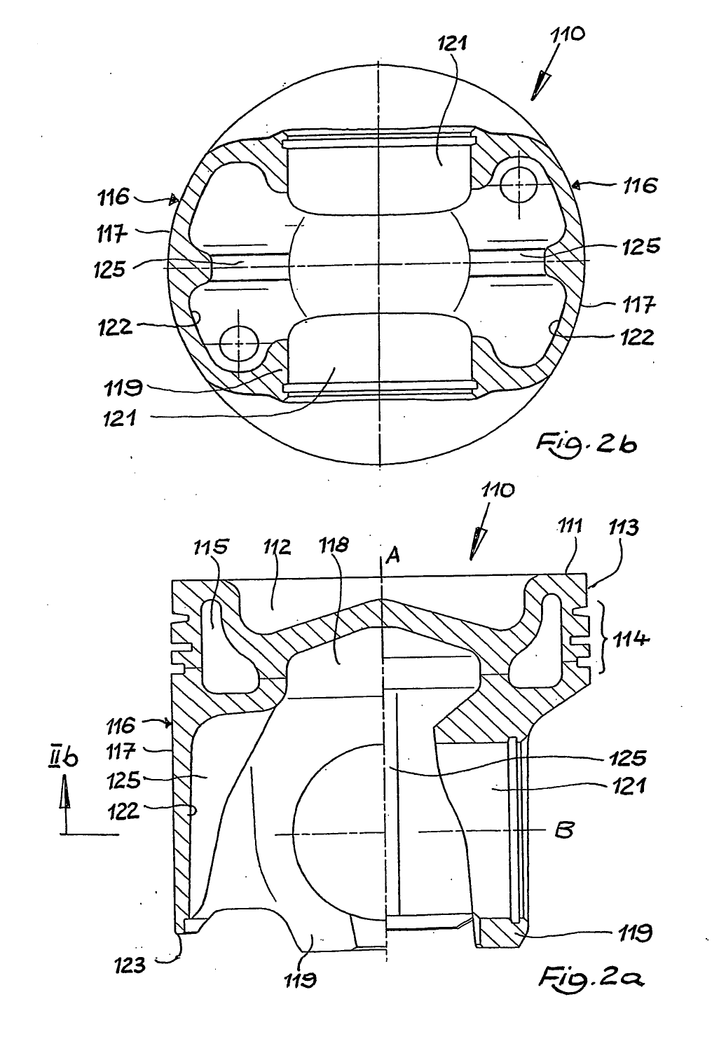

FIG. 2a another exemplary embodiment of a piston according to the invention, in a representation according to FIG. 1a;

FIG. 2b a section along the line IIb in FIG. 2a;

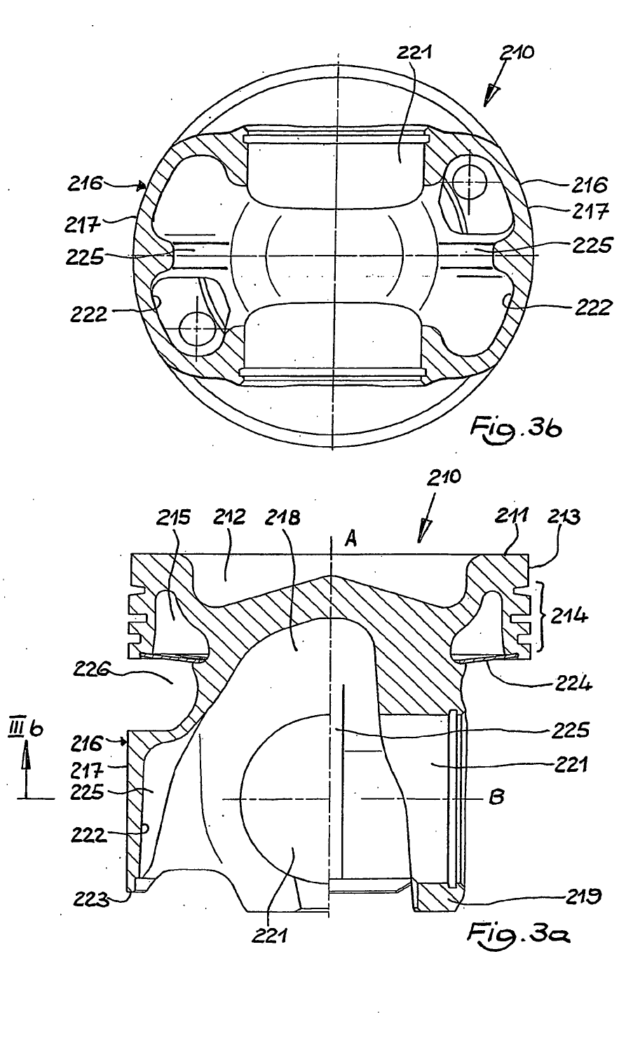

FIG. 3a another exemplary embodiment of a piston according to the invention, in a representation according to FIG. 1a;

FIG. 3b a section along the line IIIb in FIG. 3a;

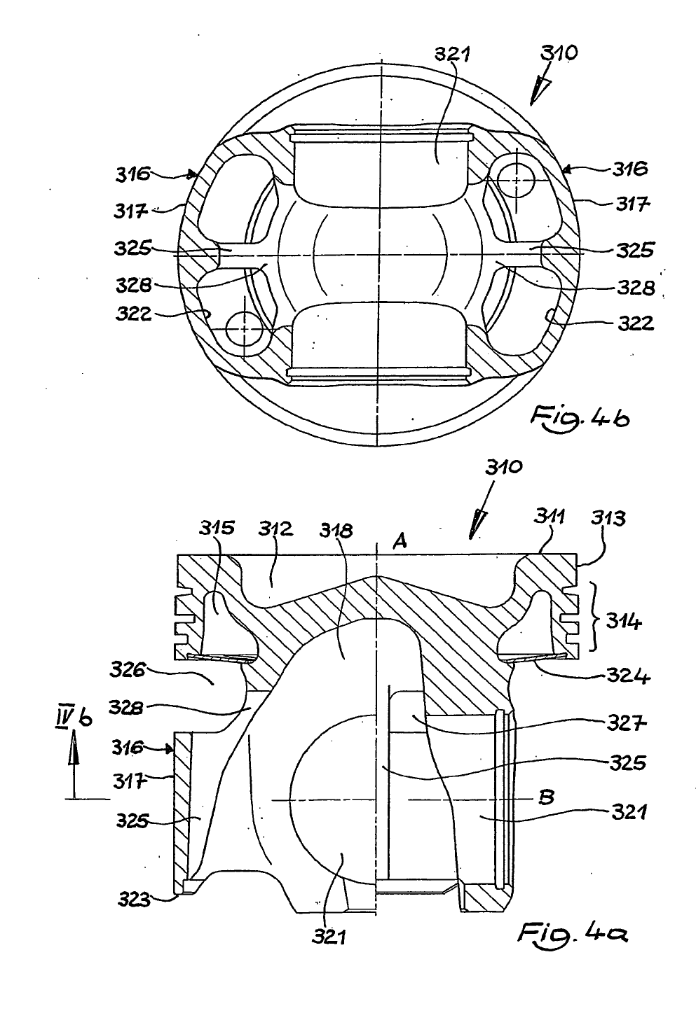

FIG. 4a another exemplary embodiment of a piston according to the invention, in a representation according to FIG. 1a;

FIG. 4b a section along the line IVb in FIG. 4a.

FIGS. 1a and 1b show a first exemplary embodiment of a piston 10, which is a one-part piston in this case. The piston 10, in known manner, has a piston head 11 having a combustion bowl 12, as well as a circumferential top land 13 and a circumferential ring belt 14. A circumferential cooling channel 15 is indicated with a dot-dash line. The piston 10 furthermore, in known manner, has a piston skirt 16, in one piece with the piston head 11 in this exemplary embodiment, having working surfaces 17. The piston head 11 is furthermore connected, in known manner, with pin bosses 19, which have pin bores 21 for accommodating a piston pin, not shown, by way of pin boss connections 18.

Two reinforcement ribs 25 that lie diametrically opposite one another, oriented parallel to the center piston axis A, are disposed on the inside wall 22 of the piston skirt 16. The reinforcement ribs 25 bring about stabilization of the piston skirt 16 in the axial direction, so that lateral force stresses that occur during operation can be absorbed in particularly reliable manner. This imparts a quieter and lower-resonance movement progression to the piston 10 according to the invention, particularly if the piston skirt 16 has an increased axial length. In the exemplary embodiment, the reinforcement ribs 25 extend from the underside of the piston head 11, i.e. below the combustion bowl 12, all the way into the region of the free end 23 of the piston skirt 16. As a result, the piston skirt 16 is stabilized over its entire axial length. In the exemplary embodiment, the reinforcement ribs 25 make a constant transition, in other words without a sharp edge being provided, into the region of the piston head 11, so that the forces that act on the piston skirt 16 are absorbed and passed away in particularly reliable manner. The placement of only two reinforcement ribs 25 that lie diametrically opposite one another, according to this exemplary embodiment, also does not lead to a significant weight increase of the piston 10 according to the invention. Nevertheless, particularly effective stabilization of the piston skirt 16 is achieved by means of this arrangement. This holds true in particular, if, as in this exemplary embodiment, the reinforcement ribs 25 are disposed crosswise to the center longitudinal axis B of the pin bores 21.

The reinforcement ribs 25 can have any desired cross-section, whereby an essentially trapezoid, arc-shaped, semicircular, or rectangular cross-section has proven to be practical.

FIGS. 2a and 2b show another exemplary embodiment of a piston 110, which is a composite piston in this case. The piston 110, in known manner, has a piston head 111 having a combustion bowl 112, as well as a circumferential top land 113 and a circumferential ring belt 114. The piston 110 furthermore has a piston skirt 116, which is separate in this exemplary embodiment, connected with the piston head 111 in known manner, which has working surfaces 117. The piston skirt 116 is furthermore connected, in known manner, with pin bosses 119, which have pin bores 121 for accommodating a piston pin, not shown, by way of pin boss connections 118. The piston head 111 and the piston skirt 116 surround a circumferential cooling channel 115.

Two reinforcement ribs 125 that lie diametrically opposite one another, oriented parallel to the center piston axis A and crosswise to the longitudinal center axis B of the pin bores 121, which have the function already described, are disposed on the inside wall 122 of the piston skirt 116. In the exemplary embodiment, the reinforcement ribs 125 extend from the upper end of the piston skirt 116 all the way to the free end 123 of the piston skirt 116. As a result, the piston skirt 116 is stabilized over its entire axial length. In this exemplary embodiment, as well, the reinforcement ribs 125 make a constant transition, in other words without a sharp edge being provided, into the upper end of the piston skirt 116, so that the forces that act on the piston skirt 116 are absorbed and passed away in particularly reliable manner.

The reinforcement ribs 125, too, can have any desired cross-section, whereby an essentially trapezoid, arc-shaped, semicircular, or rectangular cross-section has proven to be practical.

FIGS. 3a and 3b show another exemplary embodiment of a piston 210, which is a one-part piston in this case. The piston 210, in known manner, has a piston head 211 having a combustion bowl 212, as well as a circumferential top land 213 and a circumferential ring belt 214. The piston 210 furthermore, in known manner, has a piston skirt 216, in one piece with the piston head 211 in this exemplary embodiment, having working surfaces 217. The piston head 211 is furthermore connected, in known manner, with pin bosses 219, which have pin bores 221 for accommodating a piston pin, not shown, by way of pin boss connections 218. Furthermore, a circumferential cooling channel 215, open downward, i.e. towards the piston skirt 216, is provided in the piston head 211 at the level of the ring belt 214, which channel is closed off, in known manner, by means of a cover 224. A recess 226 is provided between piston head 211 and piston skirt 216, for insertion of the cover 224.

Two reinforcement ribs 225 that lie diametrically opposite one another, oriented parallel to the center piston axis A and crosswise to the center longitudinal axis B of the pin bores 221, which have the function already described, are disposed on the inside wall 222 of the piston skirt 216. In the exemplary embodiment, the reinforcement ribs 225 extend from the upper region of the piston skirt 216, approximately at the level of the pin boss connections 218, all the way into the region of its free end 223. As a result, the piston skirt 216 is stabilized over its entire axial length. In the exemplary embodiment, the reinforcement ribs 225 also make a constant transition, in other words without a sharp edge being provided, into the upper region of the piston skirt 216, so that the forces that act on the piston skirt 216 are absorbed and passed away in particularly reliable manner.

The reinforcement ribs 225 can also have any desired cross-section, whereby an essentially trapezoid, arc-shaped, semicircular, or rectangular cross-section has proven to be practical.

FIGS. 4a and 4b show another exemplary embodiment of a piston 310, which is a one-part piston in this case. The piston 310, in known manner, has a piston head 311 having a combustion bowl 312, as well as a circumferential top land 313 and a circumferential ring belt 314. The piston 310 furthermore, in known manner, has a piston skirt 316, in one piece with the piston head 311 in this exemplary embodiment, having working surfaces 317. The piston head 311 is furthermore connected, in known manner, with pin bosses 319, which have pin bores 321 for accommodating a piston pin, not shown, by way of pin boss connections 318. Furthermore, a circumferential cooling channel 315, open downward, i.e. towards the piston skirt 316, is provided in the piston head 311 at the level of the ring belt 314, which channel is closed off, in known manner, by means of a cover 324. A recess 326 is provided between piston head 311 and piston skirt 316, for insertion of the cover 324.

Two reinforcement ribs 325 that lie diametrically opposite one another, oriented parallel to the center piston axis A and crosswise to the center longitudinal axis B of the pin bores 321, which have the function already described, are disposed on the inside wall 322 of the piston skirt 316. In the exemplary embodiment, the reinforcement ribs 325 extend from the upper region of the piston skirt 316, approximately at the level of the pin boss connections 318, all the way into the region of its free end 323. As a result, the piston skirt 316 is stabilized over its entire axial length. An opening 327 is provided in the region of the recess 326, on both sides of each reinforcement rib 325, so that in this region, each reinforcement rib 325 forms a connection crosspiece 328 between the piston head 311 and the piston skirt 316. In the exemplary embodiment, the reinforcement ribs 325 also make a constant transition, in other words without a sharp edge being provided, into the lower part of the piston head 311, at the end of each connection crosspiece 328, so that the forces that act on the piston skirt 316 are absorbed and passed away in particularly reliable manner.

The reinforcement ribs 325 can also have any desired cross-section, whereby an essentially trapezoid, arc-shaped, semicircular, or rectangular cross-section has proven to be practical.

1: Piston (10, 110, 210, 310) for an internal combustion engine, having a piston head (11, 111, 211, 311) and a piston skirt (16, 116, 216, 316), wherein at least one reinforcement rib (25, 125, 225, 325) that runs parallel to the center piston axis (A) is provided on the inside wall (22, 122, 222, 322) of the piston skirt (16, 116, 216, 316).

2: Piston according to claim 1, wherein the at least one reinforcement rib (25, 125, 225, 325) extends from the region of the piston head (11, 111, 211, 311) or from the upper region of the piston skirt (16, 116, 216, 316) all the way into the region of the free end (23, 123, 223, 323) of the piston skirt (16, 116, 216, 316).

3: Piston according to claim 1, wherein the at least one reinforcement rib (25, 125, 225, 325) makes a constant transition into the region of the piston head (11, 111, 211, 311) or the upper region of the piston skirt (16, 116, 216, 316).

4: Piston according to claim 1, wherein two or more reinforcement ribs (25, 125, 225, 325) are provided.

5: Piston according to claim 4, wherein two reinforcement ribs (25, 125, 225, 325) that lie diametrically opposite one another are provided.

6: Piston according to claim 5, wherein the two reinforcement ribs are disposed crosswise to the center longitudinal axis (B) of a pin bore (21, 121, 221, 321) provided in the piston (10, 110, 210, 310).

7: Piston according to claim 1, wherein the at least one reinforcement rib (25, 125, 225, 325) has an essentially trapezoid, arc-shaped, semicircular, or rectangular cross-section.

8: Piston according to claim 1, wherein the at least one reinforcement rib (325) forms a connection crosspiece (328) between the piston head (311) and the piston skirt (316).
